(19) United States
(12) Patent Application Publication
(10) Pub. No.: US 2008/0091892 A1
(43) Pub. Date: Apr. 17, 2008

(54) Interleaving memory read/write method and apparatus executing same

(75) Inventors: Hsiu-Wen Wang, Jubei City (TW); Chao-Chung Chang, Jhonghe City (TW); Ming-Feng Yu, Hsinchu (TW)

Correspondence Address: Tung & Associates, Suite 120, 838 W. Long Lake Road, Bloomfield Hills, MI, 48302, US

(73) Assignee: Alpha Imaging Technology, R.O.C.

(21) Appl. No.: 11/581,118

(22) Filed: Oct. 13, 2006

(51) Int. Cl. G06F 13/00

(52) U.S. Cl. 711/157

(57) ABSTRACT

The present invention discloses an interleaving memory read/write method, which comprises the steps of: providing a main memory storing readable data; and non-sequentially reading the data in the main memory by batches, wherein each batch of data includes at least two data. The data read from the main memory is stored in an auxiliary memory for further processing; the further processing does not occupy the operation time of the main memory.

### BACKGROUND OF THE INVENTION

1. Field of the Invention

The present invention relates to an interleaving memory read/write method and an apparatus executing such a method, in particular to a method which improves memory access efficiency when an interleaving read/write operation is being executed, and a related apparatus for the same.

2. Description of the Related Art

An interleaving memory read/write method is to write data to a two-dimensional memory matrix along a first dimension (such as the x-direction), and to read data from the memory matrix from a second dimension (such as the y-direction). To better explain it, referring to FIG. 1A, within a given memory block 10, data are continuously and sequentially written into the memory block 10 along the horizontal direction, but are read out discontinuously, one by one, along the vertical direction, in which the original data continuity does no more exist. Or, as shown in FIG. 1B, data may be discontinuously written into the memory block 10 along the vertical direction, one data each time, but are read out continuously and sequentially along the horizontal direction. (The term “continuous(ly)” or “continuity” as used throughout this invention shall mean the existence of the original data interrelation, regardless whether the read/write action of a whole group of data may be done in more than one separate clock cycles. The term “discontinuous(ly)” or “discontinuity” as used throughout this invention shall mean the opposite, i.e., the non-existence of the original data interrelation, regardless whether the read/write action of a whole group of data may be done within a series of clock cycles. The term “sequential(ly)” as used throughout this invention shall mean to perform an action on a data having an interrelation next to a previous data, while the term “non-sequential(ly)” as used throughout this invention shall mean to perform an action on a data not having an interrelation next to a previous data, regardless whether the action is performed following a predetermined order.)

According to current memory circuit design, it is possible to horizontally read/write several (e.g., 8, 16, or 32) continuous bytes within one memory access action, the number of bytes depending on the bandwidth of associated hardware structure (such as the bandwidth of the bus and the registers). However, along the vertical direction, it is only possible to read/write one byte per memory access action.

It should be noted that the term “vertical(ly)” or “vertical direction” does not necessarily mean to form a straight line along the y-direction; as shown in FIG. 2, to read/write data with fixed number of spacing bytes is a way of “vertically” accessing data in a broad sense. Therefore, in the present invention, “horizontal(ly)” shall mean continuously and sequentially (accessing data), while “vertical(ly)” shall mean discontinuously and non-sequentially (accessing data), but with fixed number of spacing bytes.

There are several applications for the interleaving memory read/write method. One of the applications is error correction in wired or wireless data transmission, in which the transmitted data may include an error correction code (ECC) so that a receiver may correct the received data by ECC. An example of the ECC is the well-known Reed-Solomon code. Under such circumstance, error correction coding is usually performed vertically on the data. The reason for vertical coding is because data are horizontally continuously transmitted, and thus the same transmission error may affect several continuous bytes. If error correction coding is performed horizontally on the data, there may be too many erroneous bytes in one coded data group, rendering the data irrecoverable by ECC. However, if error correction coding is performed vertically on the data, it would be much less likely that a certain amount of data in one coded group are simultaneously erroneous because the data are discontinuous.

An example of the hardware circuitry for ECC is shown in FIG. 3, in which an ECC decoder 20 is provided for error correction. The ECC decoder 20 vertically read data from the memory block 10 and performs ECC decoding on the data; the ECC decoded data are written back to the memory block 10.

Besides error correction, the interleaving memory read/write method may be applied to other applications. Fo example, there may be occasions in which a portable digital imaging apparatus (such as digital camera, camera phone, or digital video recorder) is used to capture an image from one angle, but due to the hardware design of the display, the captured image may have to be displayed with 90-degree rotation. The interleaving memory read/write method may thus provide the required function. As shown in FIG. 4, a display driver circuit 30 may vertically read data from the memory block 10 and display the data on the display 40.

The aforementioned conventional interleaving memory read/write method has the following drawbacks. Wiredly or wirelessly transmitted data (including ECC), or digitally captured image data, are generally stored in the main memory of an apparatus. That is, the memory block 10 is a block in the main memory of an apparatus. In addition to providing access to these data, the main memory has to provide access to other data, such as addresses, parameters, calculation results, for other devices. The operation time of the main memory is shared by many devices, and therefore the priority to use the main memory requires arbitration. If the main memory is occupied by one device for a long time, it will exclude other devices from accessing the main memory, and the overall efficiency of the apparatus will be lowered. However, the conventional interleaving memory read/write method described above inevitably requires slow access to the main memory for non-sequentially reading/writing data. The efficiency of the main memory is poor.

In view of the foregoing drawbacks, the present invention proposes an interleaving memory read/write method which improves the main memory access efficiency. The present invention also proposes a hardware structure for implementing the method.

### SUMMARY OF THE INVENTION

A first objective of the present invention is to provide an interleaving memory read/write method which improves the main memory access efficiency.

A second objective of the present invention is to provide an ECC decoding method.

A third objective of the present invention is to provide an apparatus for executing an interleaving memory read/write method.

To achieve the foregoing objectives, according to an aspect of the present invention, an interleaving memory read/write method comprises the steps of: providing a main memory storing data to be read out; and non-sequentially reading out data from the main memory by batches, in which each batch includes at least two bytes of continuous data. The data batch read out from the main memory may be stored in an auxiliary memory for further processing, without occupying the operation time of the main memory.

According to another aspect of the present invention, an interleaving memory read/write method comprises the steps of: providing a main memory and an auxiliary memory; writing data in the auxiliary memory; and writing data from the auxiliary memory to the main memory by batches, in which each batch includes at least two bytes of continuous data.

According to a further aspect of the present invention, an ECC decoding method comprises the steps of: providing a main memory and an auxiliary memory; sending a data request signal requesting data from the main memory, the data request signal including a data address and a bytes count, wherein the bytes count is an integer equal to or greater than 2; writing data from the main memory to the auxiliary memory; and performing ECC decoding on the data in the auxiliary memory. In this method, since the data bytes count is equal to or greater than 2 for each request, for a group of data that are required for ECC decoding, it does not have to send data request signals for all the data addresses.

In addition, according to yet another aspect of the present invention, an apparatus for executing an interleaving memory read/write method comprises: a main memory; an auxiliary memory for downloading data from the main memory; and a processing circuit for non-sequentially reading out data from the auxiliary memory and processing the read out data.

According to a still other aspect of the present invention, an apparatus for executing an interleaving memory read/write method comprises: a main memory; an auxiliary memory for non-sequentially reading out data from the main memory by batches, the data read out from the main memory being non-sequentially written in the auxiliary memory; and a processing circuit for sequentially reading data from the auxiliary memory and processing the data read out from the auxiliary memory.

According to a still further other aspect of the present invention, an apparatus for executing an interleaving memory read/write method comprises: a main memory; and an auxiliary memory for non-sequentially writing data from the auxiliary memory to the main memory by batches.

According to the present invention, the number of the auxiliary memory may be increased for better efficiency.

For better understanding the objectives, characteristics, and effects of the present invention, the present invention will be described below in detail by illustrative embodiments with reference to the attached drawings.

### BRIEF DESCRIPTION OF THE DRAWINGS

FIGS. 1A, 1B and 2 explain conventional interleaving memory read/write method.

FIG. 3 schematically shows a conventional hardware arrangement for error correction.

FIG. 4 schematically shows a conventional hardware arrangement for rotating an image by 90 degrees.

FIG. 5 is a schematic circuit diagram showing a preferred embodiment of the present invention.

FIG. 6 is a flow chart explaining, as an example, how ECC decoding is performed according to another preferred embodiment of the present invention.

FIG. 7 is a schematic circuit diagram showing yet another preferred embodiment of the present invention.

FIGS. 8A and 8B are schematic circuit diagrams showing two other preferred embodiments of the present invention.

FIG. 9 explains that interleaving memory read/write method of the present invention may be used in an application which requires vertical writing and horizontal reading.

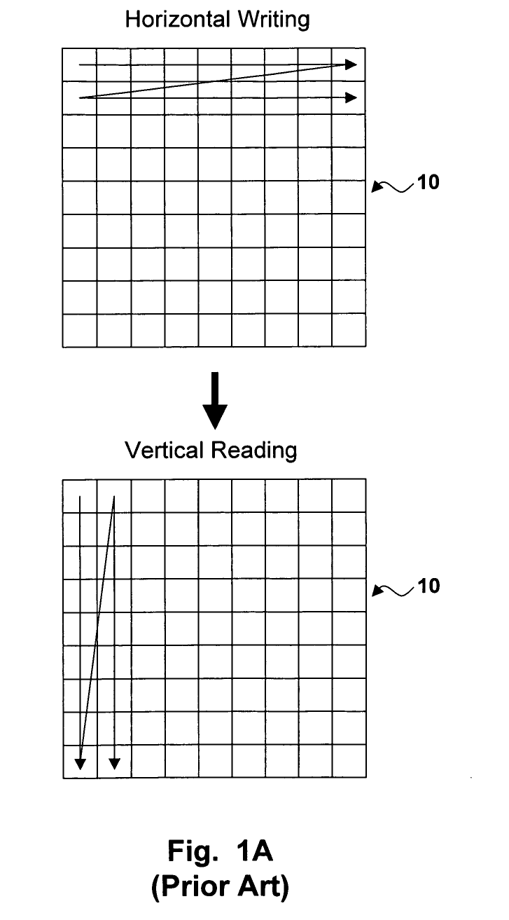

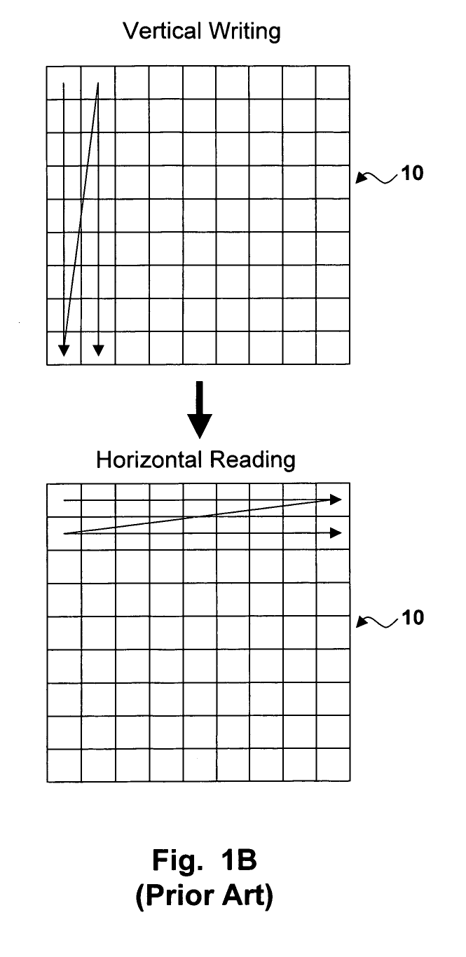

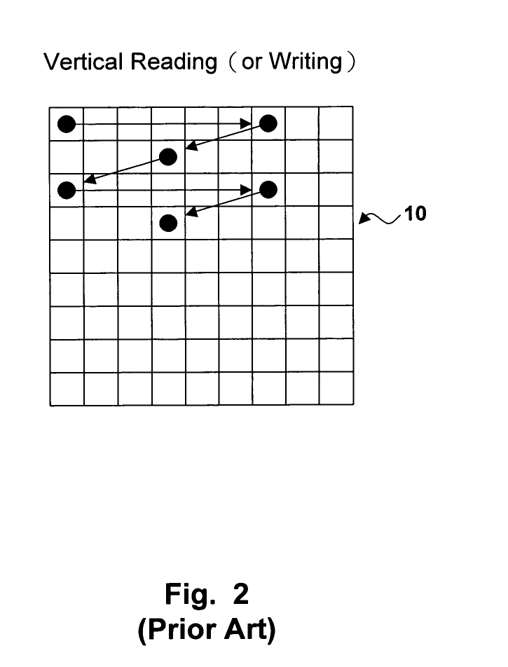

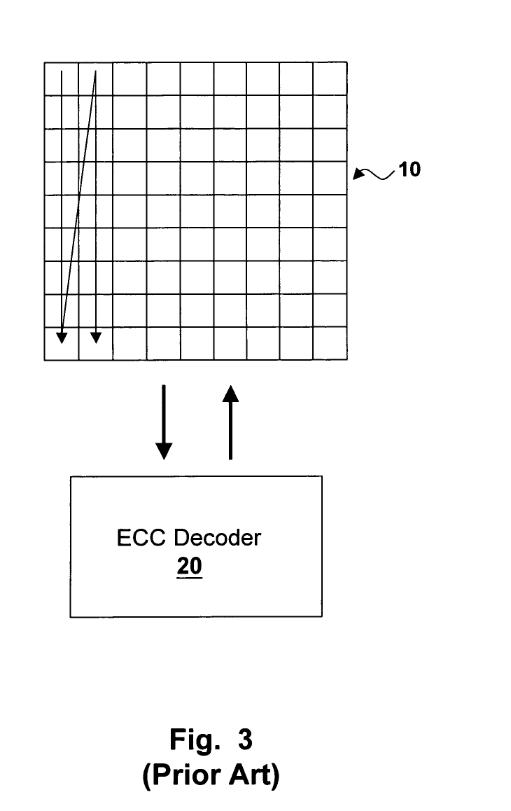

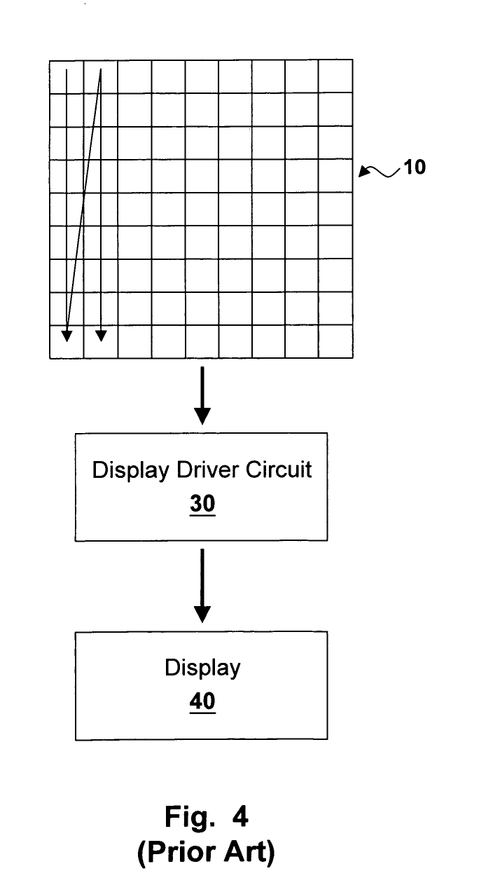

### DESCRIPTION OF THE PREFERRED EMBODIMENT

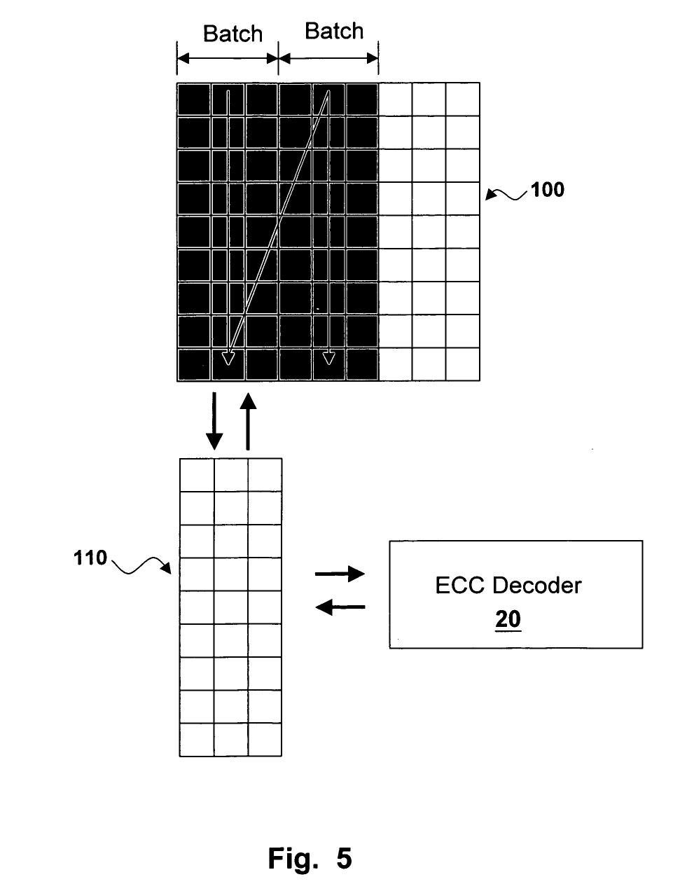

Referring to FIG. 5 which schematically shows a preferred embodiment according to the present invention, a main memory 100 and an ECC decoder 20 are provided, wherein data to be processed (e.g., to be ECC decoded) are stored in some blocks of the main memory 100. One of the major differences between the present invention and prior art is that there is also provided an auxiliary memory 110. The auxiliary memory 110 may be a stand-alone circuit, or part of an interface circuit (not shown) between the ECC decoder 20 and the main memory 100, or integrated with the ECC decoder 20.

To perform ECC decoding on the data, in prior art, the ECC decoder 20 vertically reads out data from the main memory 100 to perform error correction, and then writes the corrected data back to the main memory 100. As explained above, this is time-consuming because data is read out one by one; the efficiency of the main memory 100 is poor.

It is different, however, in the present invention. According to the present invention, the data to be processed for error correction are read out not by one byte, but by a certain number of bytes each time. The “certain number” is an integer equal to or greater than 2. At a practical maximum, the number may be the highest number of bytes accessible to the main memory 100. In the present invention, such a number is referred to as a “batch”. Thus, the present invention may be referred to as a “batch-type interleaving memory read/write method” because it accesses/processes data by batches.

The term “batch” does not imply that the access to a memory, namely the main memory, has to be stopped between two batches. The batches of data may be read out from (or written into) the memory one batch immediately following another.

After the data batches are read out from the main memory 100, they are stored into the auxiliary memory 110. When ECC decoder 20 performs error correction, it accesses the data in the auxiliary memory 110, instead of accessing the main memory 100. Thus, the ECC decoding operation does not occupy the operation time of the main memory 100.

To better explain, here is an example. For easier understanding, assuming that there are 1024*256 bytes of data to be processed; each ECC decoding group consists of 256 bytes, and the group is vertically formed by a byte from every 1024 bytes (i.e., the fixed spacing is 1023 bytes); the auxiliary memory 110 has a memory capacity of 32*256 bytes, in which the horizontal length is 32 bytes, equal to the size of a batch, and the vertical length is 256 bytes, equal to the number of bytes in an ECC decoding group.

In prior art, because the data are read out one by one, the ECC decoder 20 has to read the main memory 100 1024*256 times, occupying corresponding operation time of the main memory 100. According to the present invention, in this example, the data are read out from the main memory 100 by batches, 32-byte per batch, and sequentially written into the auxiliary memory 110. Therefore, the main memory 100 is accessed by only (1024/32)*256=32*256 times, occupying only 1/32 of the operation time of the main memory 100 as compared with prior art.

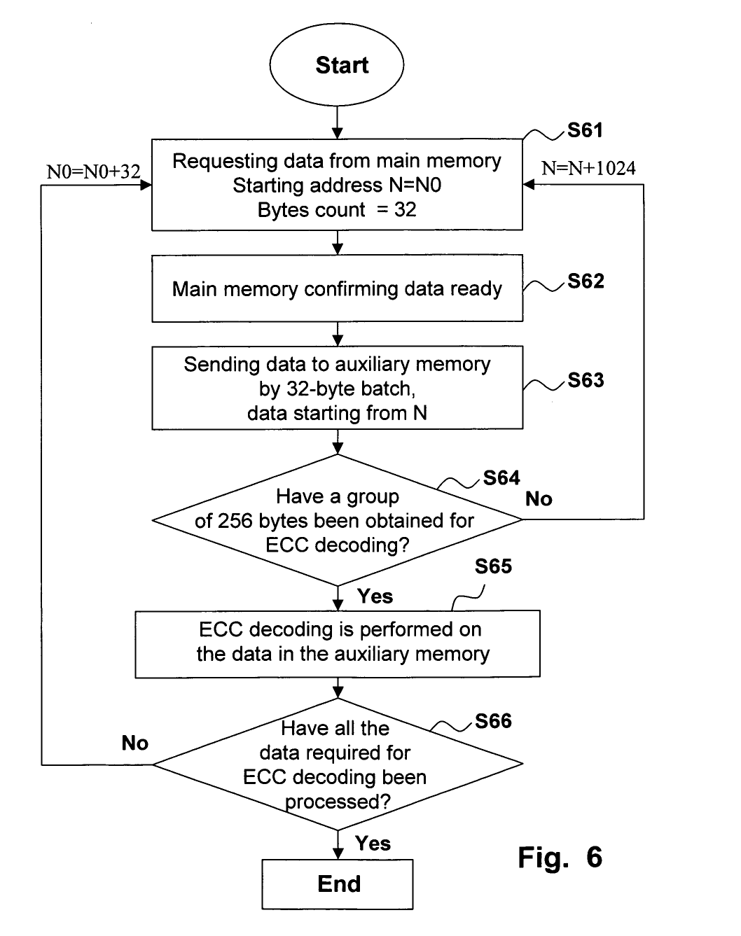

FIG. 6 shows a flow chart to better illustrate the above example. To perform error correction on the data, first in step S61, the ECC decoder 20 (or any other circuit device, such as the aforementioned interface circuit between the ECC decoder 20 and the main memory 100) sends a data request signal to the main memory 100; the data request signal includes a starting address N (initial value=NO) and a bytes count. In prior art, the bytes count is 1; in this example, the bytes count is 32 (according to the present invention, the bytes count may be any integer equal to or greater than 2). Next, in step S62, the main memory 100 confirms that its data are ready on a bus. In step S63, a 32-byte data batch (data in the addresses N to N+31) is sent through the bus to the auxiliary memory 110. Next, in step S64, it is checked whether a complete ECC group of 256 bytes are obtained for ECC decoding? (In this specific example, it is equivalent to checking whether the auxiliary memory 110 is fully filled to the last row. However, the capacity of the auxiliary memory 110 does not have to match the ECC requirement, in other examples.) If the answer to step S64 is no, another data request signal is sent to the main memory 100, with the starting address of the data being changed to N+1024, and the steps S61-S64 are repeated until all of the required 256 bytes are obtained. Next, in step S65, error correction is performed on the 32*256 bytes of data in the auxiliary memory 110, i.e., for 32 groups of ECC decoding. Thereafter, in step S66, it is checked whether all of the data bytes have been processed for error correction. If not, the data starting address is changed to N0+32, and another data request signal is sent to the main memory 100. The steps S61-S66 are repeated, until the end.

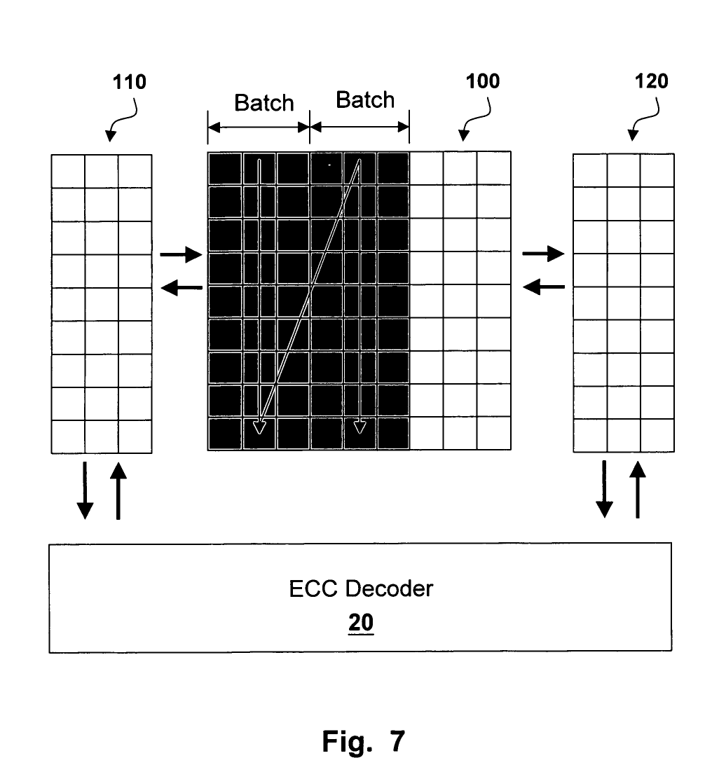

FIG. 7 schematically shows another preferred embodiment according to the present invention. This embodiment is different from the embodiment shown in FIG. 5 in that there is another auxiliary memory 120, in addition to the auxiliary memory 110. This is for improving the efficiency of the ECC decoder 20. The two auxiliary memories may be stand-alone circuits, part of an interface circuit (not shown) between the ECC decoder 20 and the main memory 100, or integrated with the ECC decoder 20.

The operation of this embodiment is as follows. Data for error correction are read from the main memory 100, and stored in one of the two auxiliary memories, e.g., the auxiliary memory 110. The ECC decoder 20 performs error correction on the data in the auxiliary memory 110, and the corrected data are written back to the auxiliary memory 110. During the time period when the ECC decoder 20 is performing error correction on the data in the auxiliary memory 110, or when the corrected data are written back to the auxiliary memory 110, the auxiliary memory 120 downloads data from the main memory 100. When the data in the auxiliary memory 110 have been corrected, the auxiliary memory 110 requests to access the main memory 100, for sending data back to the main memory 100. In the previous embodiment, the ECC decoder 20 is idle when the auxiliary memory 110 is communicating with the main memory 100. However, in this embodiment, when the auxiliary memory 110 is sending data back to the main memory 100, and when the auxiliary memory 110 is downloading data again from the main memory 100, the ECC decoder 20 may perform error correction on the data in the auxiliary memory 120, to improve overall efficiency.

The auxiliary memory 110 and the auxiliary memory 120 may be two separate memories, or two blocks in the same memory. In the latter situation, the memory may be provided with different buses for reading and writing functions, or may be arranged so that its reading and writing functions do not overlap with each other.

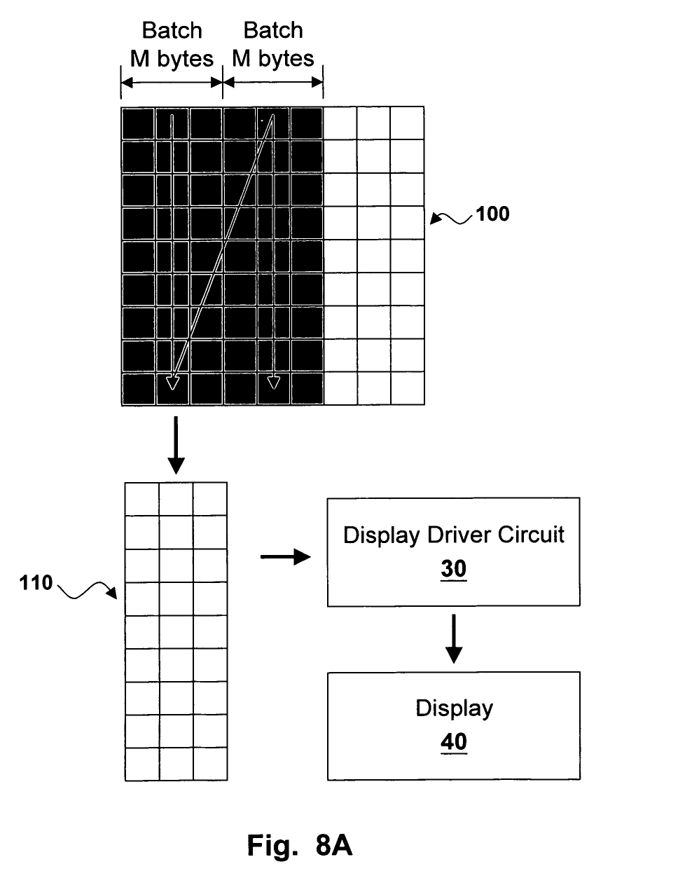

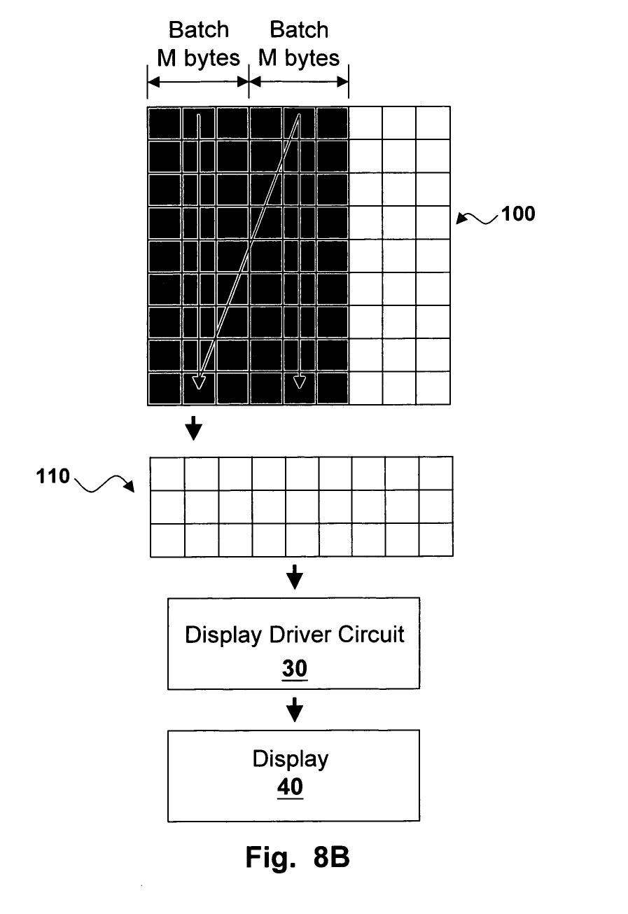

The present invention may also be applied to applications other than error correction, such as in the application for 90-degree rotation of an image. FIG. 8A shows an embodiment for such application, in which image data are vertically read out from the main memory 100 by batches, each batch including M bytes (M is an integer equal to or greater than 2). The read out data are written into the auxiliary memory 110. Next, a display driver circuit 30 vertically reads data from the auxiliary memory 110, and displays the data on a display 40. Thus, the displayed image would be rotated by 90 degrees. Or alternatively, as shown in FIG. 8B, after read out by batches, the data may be vertically written into the auxiliary memory 110. Next, the display driver circuit 30 horizontally reads data from the auxiliary memory 110, and displays the data on a display 40. More specifically, if each pixel on the display 40 is defined by image data of N bytes (N is an integer equal to or greater than 1), then if each batch includes data bytes of two or more pixels, the efficiency is improved.

The display driver circuit 30 does not have to write data back to the auxiliary memory 110, so the transmission between the display driver circuit 30 and the auxiliary memory 110 only needs to be one-directional in the embodiments of FIGS. 8A and 8B. And, similar to the embodiment shown in FIG. 7, one or more additional auxiliary memories may be added into these two embodiments, so that when the display driver circuit 30 is reading data from one auxiliary memory, another auxiliary memory may concurrently download data from the main memory 100, to improve efficiency. The structure of two or more auxiliary memories is omitted for simplicity.

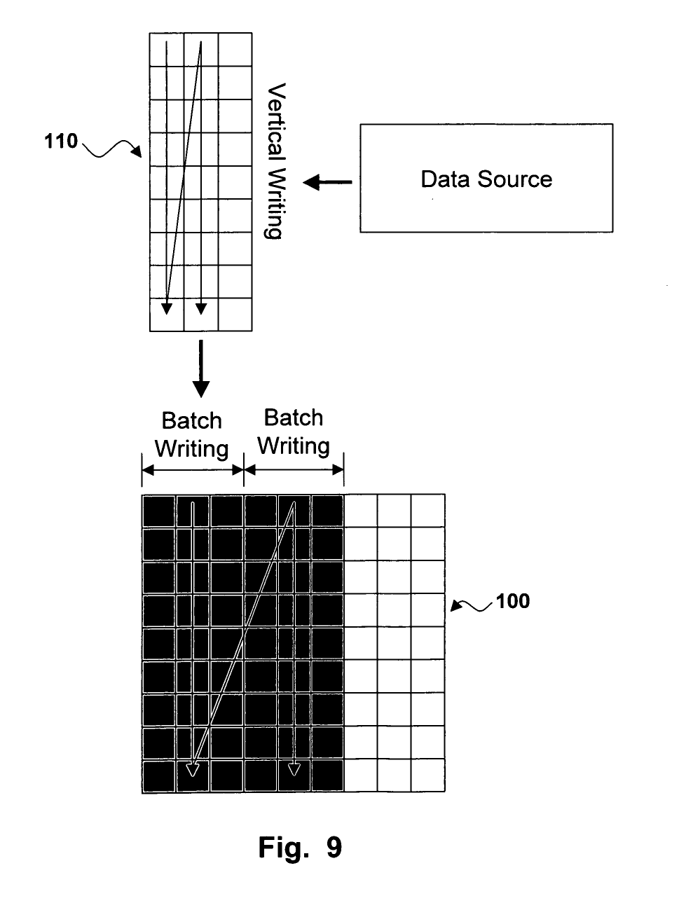

All the abovementioned embodiments are based on an interleaving memory read/write method which horizontally writes data into a main memory but vertically reads data from it. However, apparently the present invention may also be applied to an interleaving memory read/write method which vertically writes data into a main memory but horizontally reads data from it. In the latter case, it is the writing that occupies the operation time of the main memory. According to the present invention, as shown in FIG. 9, the data may be first vertically written into the auxiliary memory 110, and then read out and written into the main memory 100 by batches, to reduce the operation time of the main memory. In addition, if there is efficiency concern for data transmission from the data source to the auxiliary memory 110, one or more auxiliary memories may be added, similarly to the foregoing embodiments.

The main memory and auxiliary memories may be, but not limited to, volatile memories such as DRAMs or SRAMs.

The features, characteristics and effects of the present invention have been described with reference to its preferred embodiments, which are illustrative of the invention rather than limiting of the invention. Various other substitutions and modifications will occur to those skilled in the art, without departing from the spirit of the present invention. For example, after data are read out from the main memory by batches, they do not have to be sequentially written into the auxiliary memory; the data may be vertically written into the auxiliary memory. As another example, in all embodiments except the one shown in FIG. 8B, the horizontal length of the auxiliary memory is equal to the bytes length of a batch, but this is for simplicity in illustrating the spirit of the present invention, not for limiting the scope of the invention. The horizontal length of the auxiliary memory may be of any length. As a further example, the number of the auxiliary memories is not limited to two, but may be more. Therefore, all such substitutions and modifications are intended to be embraced within the scope of the invention as defined in the appended claims.

What is claimed is:

1. An interleaving memory read/write method comprising the steps of:
providing a main memory storing data to be read out; and
non-sequentially reading out at least a first portion of said data from said main memory by batches, in which each batch includes at least two bytes of continuous data.

2. The interleaving memory read/write method as claimed in claim 1, further comprising the step of: storing said read out data in an auxiliary memory.

3. The interleaving memory read/write method as claimed in claim 2, further comprising the step of: reading said data stored in said auxiliary memory.

4. The interleaving memory read/write method as claimed in claim 3, wherein said read out data are sequentially stored in said auxiliary memory and are non-sequentially read out from said auxiliary memory.

5. The interleaving memory read/write method as claimed in claim 3, wherein said read out data are non-sequentially stored in said auxiliary memory and are sequentially read out from said auxiliary memory.

6. The interleaving memory read/write method as claimed in claim 3, further comprising the step of: displaying said data read out from said auxiliary memory.

7. The interleaving memory read/write method as claimed in claim 6, wherein each batch includes M bytes of continuous data, and each pixel displayed by the display is defined by N bytes, in which M is an integer equal to or greater than 2; N is an integer equal to or greater than 1; and M is larger than N.

8. The interleaving memory read/write method as claimed in claim 3, further comprising the step of: performing error correction on aid data read out from said auxiliary memory.

9. The interleaving memory read/write method as claimed in claim 8, further comprising the step of: writing said data which have been error corrected back to said auxiliary memory.

10. The interleaving memory read/write method as claimed in claim 9, further comprising the step of: writing said error corrected data from said auxiliary memory to said main memory.

11. The interleaving memory read/write method as claimed in claim 1, further comprising the steps of:
providing at least a first and a second auxiliary memories;
storing said at least a first portion of data read out from said main memory, in said first auxiliary memory;
non-sequentially reading out at least a second portion of said data in said main memory by batches, in which each batch includes at least two bytes of continuous data; and
storing said at least a second portion of data read out from said main memory, in said second auxiliary memory.

12. An interleaving memory read/write method comprising the steps of:
providing a main memory and an auxiliary memory;
writing data in said auxiliary memory; and
writing data from said auxiliary memory to said main memory by batches, in which each batch includes at least two bytes of continuous data.

13. The interleaving memory read/write method as claimed in claim 12, wherein said step of writing data in said auxiliary memory sequentially writes in said auxiliary memory.

14. The interleaving memory read/write method as claimed in claim 12, wherein said step of writing data in said auxiliary memory non-sequentially writes in said auxiliary memory.

15. An error correction code (ECC) decoding method comprises the steps of:
(A) providing a main memory and an auxiliary memory;
(B) sending a data request signal requesting data from said main memory, said data request signal including a data address and a bytes count, wherein said bytes count is an integer equal to or greater than 2;
(C) writing data from said main memory to said auxiliary memory; and
(D) performing ECC decoding on said data in said auxiliary memory.

16. The ECC decoding method as claimed in claim 15, wherein said steps of (B) and (C) are repeated at least twice, and then step (D) is taken.

17. The ECC decoding method as claimed in claim 15, wherein said steps (C) and (D) are performed for every data required for ECC decoding, and said steps (B) to (D) are repeated if the number of data required for ECC decoding is larger than the capacity of said auxiliary memory; and wherein the number of all the data addresses in step (B) is smaller than the number of data required for ECC decoding.

18. An apparatus for executing an interleaving memory read/write method, comprising:
a main memory;
an auxiliary memory for downloading data from said main memory; and
a processing circuit for non-sequentially reading out data from said auxiliary memory and processing said read out data.

19. The apparatus as claimed in claim 18, wherein said auxiliary memory non-sequentially downloads data from said main memory by batches, each batch including at least two bytes of continuous data.

20. The apparatus as claimed in claim 18, wherein said processing circuit is a display driver circuit for processing data to be displayed.

21. The apparatus as claimed in claim 18, wherein said processing circuit is an ECC decoder processing data for error correction.

22. The apparatus as claimed in claim 18, further comprising at least one more auxiliary memory.

23. An apparatus for executing an interleaving memory read/write method, comprising:
a main memory;
an auxiliary memory for non-sequentially reading out data from said main memory by batches, said data read out from said main memory being non-sequentially written into said auxiliary memory; and
a processing circuit for sequentially reading data from said auxiliary memory and processing said data read out from said auxiliary memory.

24. The apparatus as claimed in claim 23, wherein said processing circuit is a display driver circuit for processing data to be displayed.

25. The apparatus as claimed in claim 23, wherein said processing circuit is an ECC decoder processing data for error correction.

26. The apparatus as claimed in claim 23, further comprising at least one more auxiliary memory.

27. An apparatus for executing an interleaving memory read/write method, comprising:
a main memory; and
an auxiliary memory for non-sequentially writing data from said auxiliary memory to said main memory by batches.

28. The apparatus as claimed in claim 23, wherein said auxiliary memory stores data which are non-sequentially written into said auxiliary memory.
